(19) United States
(12) Patent Application Publication
(10) Pub. No.: US 2008/0191556 A1
(43) Pub. Date: Aug. 14, 2008

(54) Uninterruptible Power Supply for the Back up of Dc Power Source

(75) Inventors: Myoungshin Hong, Kyunggi-do (KR); Byung Chul Kim, Seoul (KR); Donghwan Jang, Kyunggi-do (KR); Sungcheul Park, Seoul (KR); Jongho Park, Seoul (KR)

Correspondence Address: HOFFMANN & BARON, LLP, 6900 JERICHO TURNPIKE, SYOSSET, NY, 11791, US

(73) Assignee: EPPSCORE CO., LTD., Seoul (KR)

(21) Appl. No.: 11/997,039

(22) PCT Filed: Jul. 26, 2006
(86) PCT No.: PCT/KR2006/002941

§ 371 Date: Jan. 28, 2008

(30) Foreign Application Priority Data
Jul. 28, 2005 (KR) 10-2005-0069162

(51) Int. Cl. H02J 9/00

(52) U.S. Cl. 307/64

(57) ABSTRACT

The present invention relates to an uninterruptible power supply for the backup of DC power source. The uninterruptible power supply for the backup of DC power source in accordance with the present invention comprises: a) an energy storage device that stores extra DC energy from the DC power source; b) a charging circuitry that charges the extra DC energy from the DC power source into the energy storage device; c) a control circuitry that controls charging and discharging; and d) a discharging circuitry that supplies DC energy from the energy storage device to the output load, wherein the discharging circuitry has a dual output structure comprised of a relay that outputs DC energy proportional to a charging voltage of the energy storage device from the energy storage device to the output load, and a DC/DC converter that outputs DC energy having a constant voltage, at a momentary power interruption or a relay failure, from the energy storage device to the output load, and wherein the relay and the DC/DC converter are arranged in parallel.

### TECHNICAL FIELD

The present invention relates to an uninterruptible power supply, more particularly to an uninterruptible power supply for the backup of DC power source.

### BACKGROUND ART

Uninterruptible power supply (UPS) is an apparatus which supplies stable power to productive facilities at a momentary power interruption. More specifically, as shown in FIG. 1, the uninterruptible power supply stores an extra electric energy from a power source into an energy storage device and supplies stable power to an output load at a momentary power interruption

The uninterruptible power supply may be divided into an AC (alternative current) power backup type and a DC (direct current) power backup type. The AC power backup UPS converts an AC power from an AC power source to a DC power using a transformer and an AC/DC converter to store extra electric energy into an energy storage device. When a power failure or instantaneous power abnormality occurs, the DC output from the energy storage device is converted to an AC power using a DC/AC inverter to supply the same AC power with that of the AC power source to an output load. This type of UPS has advantages that because the same AC power with that of the AC power source can be provided, the UPS can backup a plurality of output loads at the same time and that the UPS can supply power to various output loads from one an AC power source, including motor, etc. However, the AC power backup UPS is suffered from the disadvantages that circuitry elements required for the construction of the UPS, including transformer, AC/DC inverter, etc., requires large volume and heavy weight and that an electrochemical capacitor having large volume and weight should be used due to energy loss in the DC/AC inverter.

To the contrary, the DC power backup UPS stores extra DC energy from a DC power source into an energy storage device and provides the energy from the energy storage device to an electronic apparatus requiring a DC voltage at a power failure or instantaneous instability of the DC power source such as voltage sag. The DC power backup UPS has the advantage that because of relatively simple circuitry construction compared with the AC power source backup type, it can be installed easily and small-sized.

Japanese Patent Laid-Open No. 5-122871 discloses an uninterruptible power supply for the backup of DC power source. In this patent, a DC/DC converter connected in serial to a DC power source is used as a discharging circuitry, which enables the construction of an uninterruptible power supply with small volume and weight because of simple circuitry. But, such a circuitry construction is associated with intrinsic degradation because it is based on the continuous operation of the DC/DC converter. Further, electrical impact may be applied to the DC/DC converter by the instantaneous overload at the output load, resulting in the failure of internal devices. Consequently, stable operation of the uninterruptible power supply is not attainable.

To solve this problem, Japanese Patent Laid-Open No. 2002-199619 discloses another uninterruptible power supply for the backup of DC power source. The uninterruptible power supply for the backup of DC power source of this patent is characterized in that electrical energy is stored in an electrochemical capacitor through a charging circuitry and a DC/DC converter is operated only at a failure of the power supply from a power source, due to a combinational action of a power output detection circuitry and a control circuitry. Since the DC/DC converter is operated only at the instability in the input power source, the deterioration problem resulted from the degradation of circuitry elements, can be minimized. Further, when an internal failure occurs in the DC/DC converter, the supply from the power source is not interrupted. But, this circuitry construction is disadvantageous in that, since the operation of the DC/DC converter is responsive to the instability of the input power source, it cannot effectively cope with the instability of the input power source resulting from the output load side, including instantaneous overload or fluctuation of the output load.

### DISCLOSURE OF INVENTION

### Technical Problem

An object of the present invention is to provide an uninterruptible power supply for the backup of DC power source capable of: i) supplying stable power to an output load at a momentary power interruption; ii) protecting an input power source from instantaneous overload at the output load; and iii) supplying stable power even at a failure of the internal circuitry.

### Technical Solution

According to a preferred embodiment of the present invention, there is provided an uninterruptible power supply for the backup of DC power source connected in parallel between a DC power source that supplies DC energy and an output load that is operated by the DC energy, comprising: a) an energy storage device that stores extra DC energy from the DC power source; b) a charging circuitry that charges the extra DC energy from the DC power source into the energy storage device; c) a control circuitry that controls charging and discharging; and d) a discharging circuitry that supplies DC energy from the energy storage device to the output load, wherein the discharging circuitry has a dual output structure comprised of a relay that outputs DC energy proportional to a charging voltage of the energy storage device from the energy storage device to the output load, and a DC/DC converter that outputs DC energy having a constant voltage, at a momentary power interruption or a relay failure, from the energy storage device to the output load, and wherein the relay and the DC/DC converter are arranged in parallel.

The uninterruptible power supply for the backup of DC power source in accordance with the present invention comprises a discharging circuitry having a dual output structure. A first discharging circuit is comprised of the relay and a second discharging circuit is comprised of the DC/DC converter. The first discharging circuit and the second discharging circuit are connected to the energy storage device (or to the output load) in parallel. When an instantaneous overload occurs at the output load, DC energy corresponding to the overloaded power is delivered through the relay to the output load. The delivery of the DC energy stored in the energy storage device through the relay enables to actively deal with the instantaneous overload or fluctuation at the side of the output load. The power supply from the relay to the output load protects the DC power source from an instantaneous overload. The DC/DC converter, that constitutes the second discharging circuit, outputs a constant voltage to the output load under the control of the control circuitry at a momentary power interruption. This enables normal operation of the output load at a failure of the input DC power source. Further, the parallel arrangement of the first discharging circuit and the second discharging circuit enables, even in a case one of the two discharging circuits is not functioning properly, to supply the energy stored in the energy storage device to the output load through the other discharging circuitry, thereby improving the reliability of power supply.

According to another preferred embodiment of the present invention, there is provided an uninterruptible power supply, wherein the energy storage device is an electrochemical capacitor.

According to still another preferred embodiment of the present invention, there is provided an uninterruptible power supply, wherein the charging circuitry comprises a current limiting circuit that charges the extra DC energy into the electrochemical capacitor at the same voltage with that of the DC power source and a voltage detection circuit that detects the input voltage from the DC power source to the current limiting circuit and the output voltage of the electrochemical capacitor.

According to still further another preferred embodiment of the present invention, there is provided an uninterruptible power supply, wherein an anti-reverse current diode for protecting reverse current flow is interposed in a passage through which the DC energy flows from the relay to the output load.

### Advantageous Effects

The uninterruptible power supply for the backup of DC power source in accordance with the present invention provides the following advantages.

(1) Power supply to the output load is performed stably even at an instability of the DC power source, including instantaneous power interruption.

(2) Even when an instantaneous overload occurs at the output load, no voltage drop occurs at the input DC power source. Consequently, the DC power source is stably protected.

(3) The dual output structure enables to supply stable power even in a case that one of the discharging circuits is not functioning properly. This improves reliability of the uninterruptible power supply.

(4) The employment of an electrochemical capacitor as energy storage device reduces the maintenance cost of the uninterruptible power supply.

(5) An anti-reverse current diode is preferably interposed in a passage through which the DC power flows from the relay (the first discharging circuit) to the output load. This improves energy efficiency of the DC/DC converter (the second discharging circuit), which results in the increase of backup time. Further, the weight and volume of the energy storage device required to attain the same backup time are reduced.

(6) Since the DC/DC converter operates only at a momentary power interruption or a failure of the first discharging circuit, intrinsic deterioration can be minimized.

### BRIEF DESCRIPTION OF THE DRAWINGS

FIG. 1 is a block diagram schematically illustrating representative example of conventional uninterruptible power supply.

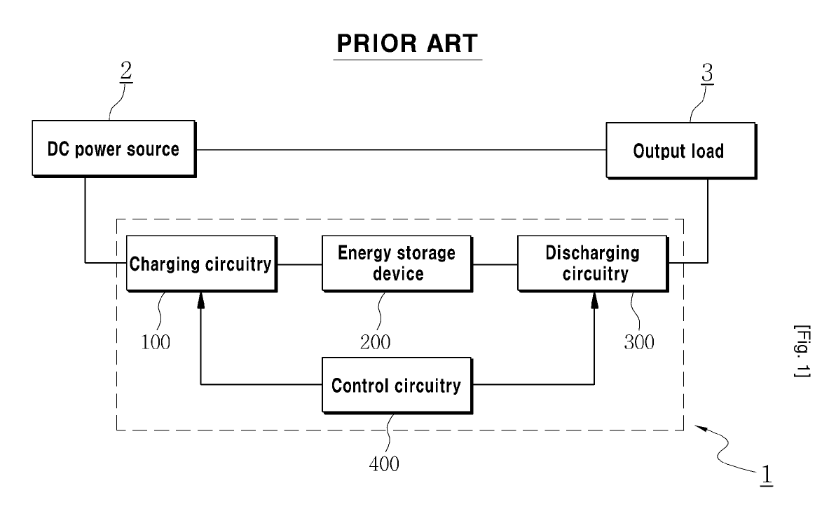

FIG. 2 is a block diagram schematically illustrating a preferred embodiment of the uninterruptible power supply for the backup of DC power source in accordance with the present invention.

FIG. 3 is a block diagram schematically illustrating another preferred embodiment of the uninterruptible power supply for the backup of DC power source in accordance with the present invention.

FIG. 4 is a graph showing output voltage characteristics of the electrochemical capacitor employed in the uninterruptible power supply and of the uninterruptible power supply at a momentary power interruption, in accordance with the present invention.

FIG. 5 presents graphs showing the output voltage characteristics of the uninterruptible power supply for the backup of DC power source at a momentary power interruption of Test Example 1, (a) being the input voltage of the DC power source and (b) being the output voltage to the output load.

FIG. 6 presents graphs showing the output voltage characteristics of the uninterruptible power supply for the backup of DC power source at an instantaneous overload of Test Example 2 in accordance with the present invention, (a) being the voltage characteristics of the DC power source without uninterruptible power supply and (b) being the voltage characteristics of the DC power source equipped with the uninterruptible power supply.

### MODE FOR THE INVENTION

As aforementioned, the conventional uninterruptible power supply for the backup of DC power source suffered from the disadvantages: instable power supply to an output load at a momentary power failure; low reliability of the power supply at an instantaneous overload in the output load; and susceptibility to the damage to the input power source at an instantaneous overload in the output load.

In order to solve the problem of the conventional uninterruptible power supply for the backup of DC power source, the present inventors designed a dual output discharging circuitry that supplies DC energy from the energy storage device to the output load, being comprised of a first discharging circuit comprising a relay and a second discharging circuit comprising a DC/DC converter. Such a discharging circuitry is capable of providing high-quality power with constant voltage to the output load through the DC/DC converter at a momentary power interruption or other failure at a side of the input DC power source. Further, it protects the DC power source by delivering the high-output electrical energy stored in the energy storage device through the relay at an instantaneous overload at a side of the output load. Such a dual output structure makes it possible to provide an uninterruptible power supply for the backup of DC power source with high reliability, because even when one of the discharging circuits is not functioning properly, power supply can be sustained using the other discharging circuitry.

The uninterruptible power supply of the present invention connected in parallel between a DC power source that supplies DC energy and an output load that is operated by the DC energy, comprising: a) an energy storage device that stores extra DC energy from the DC power source; b) a charging circuitry that charges the extra DC energy from the DC power source into the energy storage device; c) a control circuitry that controls charging and discharging; and d) a discharging circuitry that supplies DC energy from the energy storage device to the output load, wherein the discharging circuitry has a dual output structure comprised of a relay that outputs DC energy proportional to a charging voltage of the energy storage device from the energy storage device to the output load, and a DC/DC converter that outputs DC energy having a constant voltage, at a momentary power interruption or a relay failure, from the energy storage device to the output load, and wherein the relay and the DC/DC converter are arranged in parallel.

Preferably, the energy storage device is an electrochemical capacitor. At present, a battery and an electrochemical capacitor are typically used as energy storage device of an uninterruptible power supply. The battery has a high energy density in a range from 20 to 120 Wh/kg. However, it has a low output density in a range of 50 to 250 W/kg and a short cycle life of about 500 cycles. Thus, an uninterruptible power supply equipped with the battery as an energy storage device can supply power for a long time because of high energy density. But, it requires regular maintenance because of the short cycle life, increasing maintenance cost. In contrast, the electrochemical capacitor has a lower energy density in a range of from 1 to 5 W/kg than that of the battery, but has a very high output density of from 1000 to 2000 W/kg and its cycle life is almost semi-permanent. Thus, while the uninterruptible power supply equipped with an electrochemical capacitor as an energy storage device is not adequate for long-term power supply due to low energy density, it can minimize the maintenance cost because of superior cycle life. Accordingly, it is adequate for coping with short-term power instability such as instantaneous power failure.

In accordance with the present invention, charging to the electrochemical capacitor is preferably performed with the same voltage with that of the DC power source. For this purpose, a current limiting circuit is employed. The input voltage from the DC power source to the current limiting circuit and the output voltage of the electrochemical capacitor are detected by a voltage detection circuit. The voltage information detected by the voltage detection circuit is delivered to a control circuitry. Based on the voltage information detected by the voltage detection circuit, the control circuitry controls discharge of the energy stored into the electrochemical capacitor.

According to more preferred embodiment of the uninterruptible power supply of the present invention, an anti-reverse current diode for protecting reverse current flow is interposed in a passage through which the DC energy is supplied from the relay to the output load. In this configuration, the energy delivered through the DC/DC converter to the output load at a momentary power interruption is dominantly applied to the output load. Consequently, the efficiency of the electrical energy stored in the electrochemical capacitor is improved, and this reduces the weight and volume of the energy storage device.

Hereinafter, the present invention will be more fully illustrated referring to accompanied drawings.

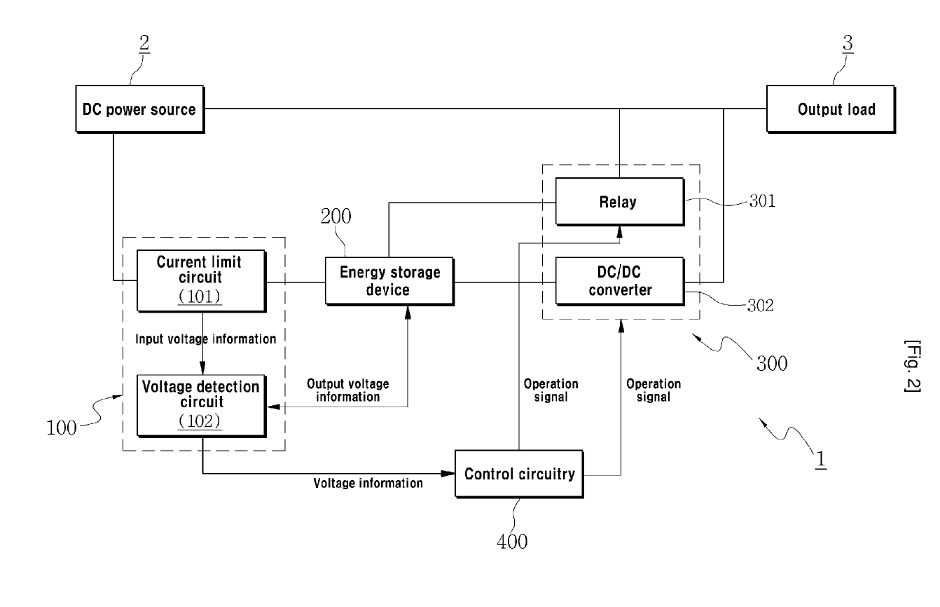

FIG. 2 is a block diagram schematically illustrating a preferred embodiment of the uninterruptible power supply for the backup of DC power source in accordance with the present invention. As shown in FIG. 2, the uninterruptible power supply of the present invention (1) is connected in parallel between a DC power source (2) and an output load (3) and comprises a charging circuitry (100), an energy storage device (200), a discharging circuitry (300) and a control circuitry (400). The discharging circuitry (300) comprises a first discharging circuit, which is comprised of a relay (301), and a second discharging circuit, which is comprised of a DC/DC converter (302).

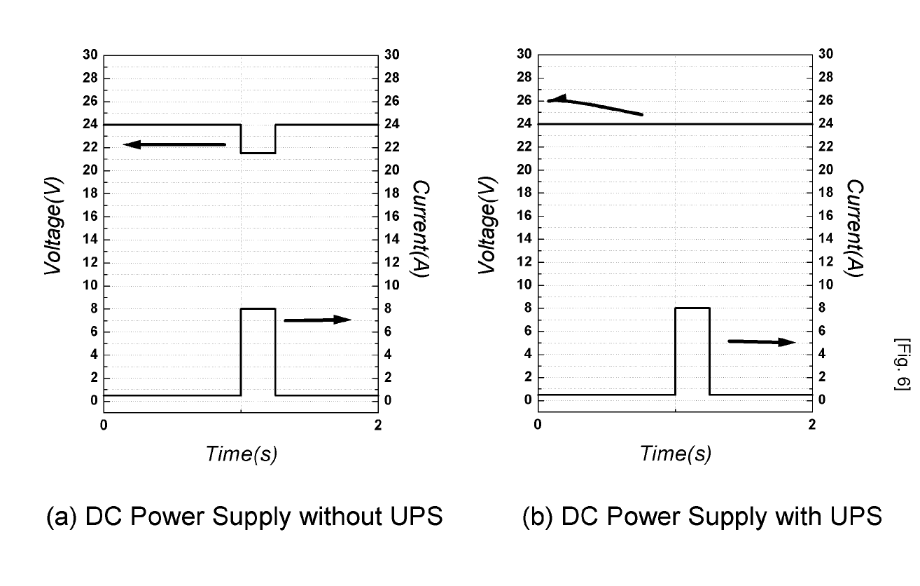

The first discharging circuit is comprised of the relay (301), and outputs to the output load (3) a DC energy in which the voltage thereof is proportional to the charging voltage of the energy storage device (200). This kind of power supply utilizes high output characteristics of the energy storage device (200) and supplements output characteristics of the DC power source (2). In general, an instantaneous overload or abrupt load fluctuation at a side of the output load (3), for example an electronic device, results in power instability or power deficiency of the DC power source (2). This may cause damage to the DC power source (2) due to an over-current. The possible damage to the DC power source (2) may interrupt stable operation of the output load (3). When an instantaneous overload occurs at a side of the output load (3), the uninterruptible power supply of the present invention (1) delivers the DC energy stored into the energy storage device (200) to the output load (3) through the relay that constitutes the first discharging circuit (301). That is, when an instantaneous overload occurs at the output load (3), the extra electrical energy stored into the energy storage device (200) is used for the backup of the DC power source (2). In this case, the uninterruptible power supply (1) acts as a supplementary power source for the overloaded energy, thereby protecting the DC power source (2) from the overload. Details on the protection of the DC power source (2) from the instantaneous overload by the relay (301) will be described later referring to FIG. 6.

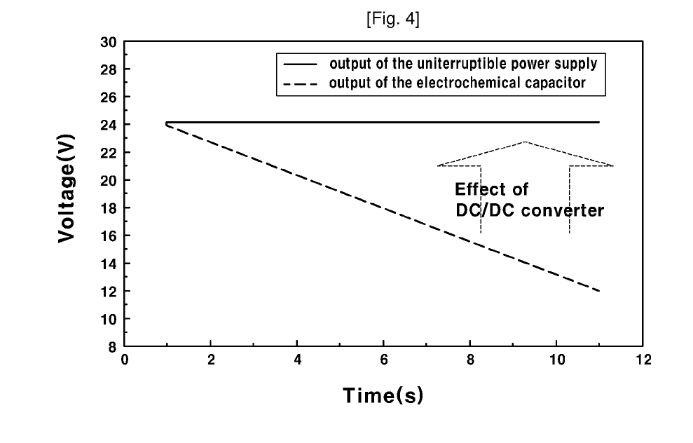

The second discharging circuit comprised of the DC/DC converter (302) supplies, at a power failure, the energy required for normal operation of the output load. FIG. 4 is a graph showing output voltage characteristics of the electrochemical capacitor that acts as the energy storage device (200), and discharge characteristics through the DC/DC converter (302). As shown in FIG. 4, the voltage of the electrochemical capacitor, or the energy storage device (200), decreases linearly during discharge. At a momentary power interruption in the DC power source (2), the electrochemical capacitor (200), will supply a linearly decreasing voltage to the output load (3) through the relay that constitutes the first discharging circuit (301). This situation interrupts stable operation of the output load (3). In a case of a momentary power interruption, electrical energy is supplied from the energy storage device (200) to the output load (3) through the DC/DC converter which constitutes the second discharging circuit (302). Consequently, a constant voltage can be provided to the output load even at a momentary power interruption. FIG. 4 explicitly shows that the output voltage of the DC/DC converter (302) is maintained to a constant value even though the output voltage of the electrochemical capacitor (200) linearly decreases at a momentary power interruption. This means that the uninterruptible power supply for the backup of DC power source in accordance with the present invention can stably supply high-quality power to the output load even at a power failure of the DC power source.

The discharging circuitry (300) having a dual structure of the first discharging circuit (301) and the second discharging circuit (302) provides high reliability against internal failure. The uninterruptible power supply of the present invention (1) has a dual discharging circuitry structure of the first discharging circuit (301) and the second discharging circuit (302). Each discharging circuitry (301, 302) is connected in parallel to the output load (3). Thus, even when an internal failure occurs at one of the discharging circuits, power supply can be attained using the other discharging circuitry. And, even in the worst case where both the discharging circuits are out of order, normal power supply can be attained with aid of the input power source connected to the output load.

Preferably, the energy storage device (200) employed in the uninterruptible power supply of the present invention (1) is an electrochemical capacitor. For example, the electrochemical capacitor may be an electric double layer capacitor composed of two electrodes made of active carbon material (preferably, activated carbon), a pseudo-capacitor composed of two electrodes, wherein Faradaic reaction occurs at one electrode and non-Faradaic reaction occurs at the other electrode, or a pseudo-capacitor composed of two electrodes, wherein non-Faradaic reaction is activated by a Faradaic reaction at one electrode and a non-Faradaic reaction occurs at the other electrode. In the specific examples of the present invention, an electric double layer capacitor was used, but this is only exemplary and for the purpose of illustration.

Preferably, the charging circuitry (100) comprises a current limiting circuit (101) that charges extra DC energy into the energy storage device (200) at the same voltage with that of the DC power source (2) and a voltage detection circuit (102) that detects the input voltage from the DC power source (2) to the current limiting circuit (101) and the output voltage of the energy storage device (200). Specifically, the uninterruptible power supply (1) charges extra electrical energy from the DC power source (2) into the energy storage device (200), specifically into the electrochemical capacitor, through the current limiting circuit (101). Then, the voltage of the electrochemical capacitor linearly increases. And, the voltage detection circuit (102) detects input voltage from the DC power source (2) to the current limiting circuit (101) and the output voltage of the electrochemical capacitor (200), and delivers the detected voltage information to the control circuitry (400).

The control of charging and discharging by the control circuitry (400) is as follows. If the output voltage (or the charging voltage) of the electrochemical capacitor (200) detected by the voltage detection circuit (102) reaches to the range of 70% to 100% of the output voltage of the input DC power source, the control circuitry (400) operates the relay that constitutes the first discharging circuit (301), so that the electrochemical capacitor (200) is connected to the output load in parallel with the DC power source (2). At the same time, the control circuitry (400) connects the second discharging circuit, or the DC/DC converter (302) in parallel with the relay (301). In case the initial setup is maintained normally, the control circuitry (400) performs control so that the electrical energy is delivered through the DC/DC converter (302) only when the input voltage from the DC power source (2) to the current limiting circuit (101) detected by the voltage detection circuit (102) decreases abruptly or when delivery of electrical energy through the relay (301) is not performed. Thus, the delivery of electrical energy through the DC/DC converter (302) takes place only at a momentary power interruption of the DC power source or an abnormality of the first discharging circuit (301). This significantly reduces the intrinsic deterioration of the DC/DC converter (302). At an instantaneous overload or an ordinary condition, the control circuitry (400) performs control so that the electrical energy is delivered through the first discharging circuit (301).

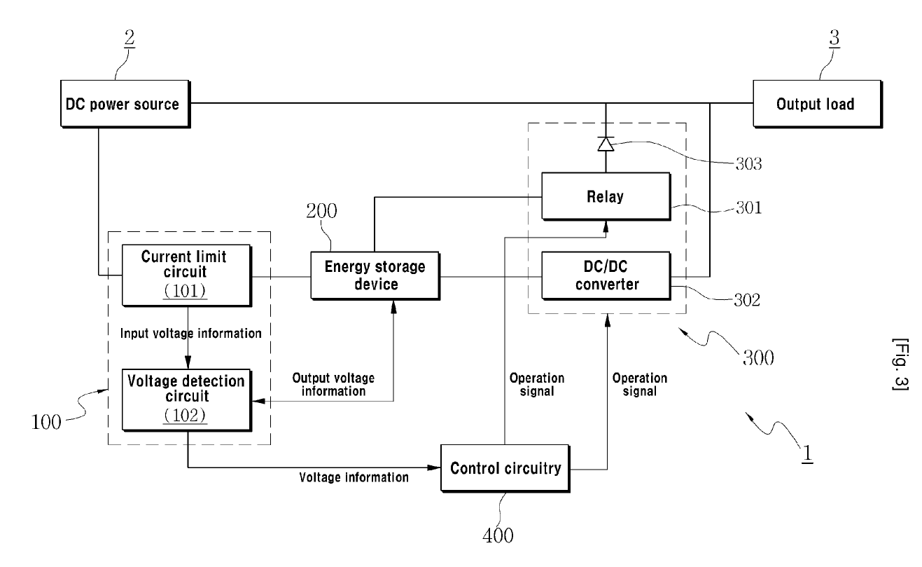

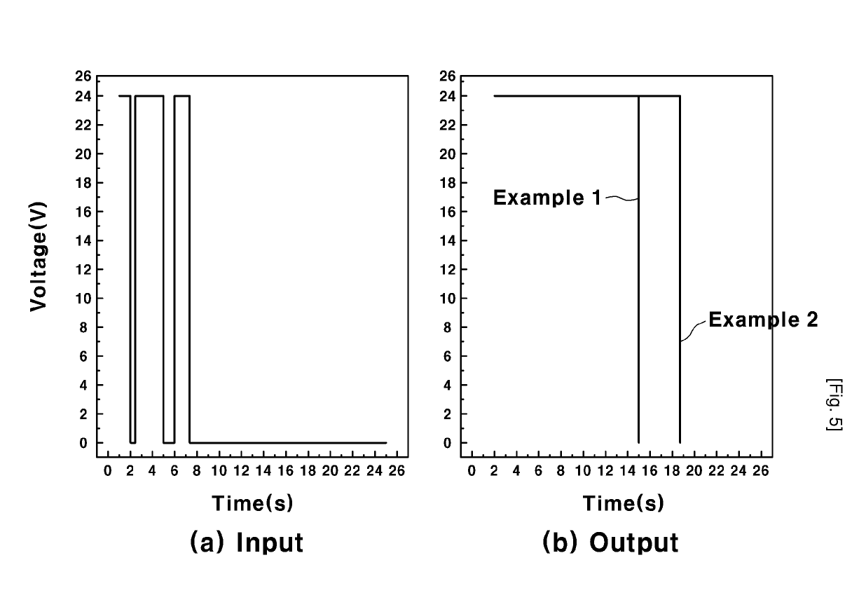

FIG. 3 is a block diagram schematically illustrating another preferred embodiment of the uninterruptible power supply for the backup of DC power source in accordance with the present invention. As shown in FIG. 3, an anti-reverse current diode (303) for protecting reverse current flow is interposed in a passage through which DC power flows from the relay (301) to the branch between the DC power source (2) and the output load (3). The anti-reverse current diode (303) improves the energy efficiency of the DC/DC converter (302), or the second discharging circuit, at a momentary power interruption. In the uninterruptible power supply of the present invention (1), the first discharging circuit (301) and the second discharging circuit (302) are connected to the output load (3) in parallel. Accordingly, the output power of the second discharging circuit (302) may be used to recharge the first discharging circuit (301), which diminishes an efficient power flow. This decreases the efficiency of the electrical energy stored into the energy storage device (200), thereby making a higher-capacity energy storage device (200) required. At a momentary power interruption, the anti-reverse current diode (303) blocks the power flow from the DC/DC converter (302) to the first discharging circuit (301). This means that the power flow from the DC/DC converter (302) can be directed dominantly to the output load (3). Consequently, the efficiency of the energy stored in the energy storage device (200) is improved and the volume and weight of the energy storage device (200) can be reduced. Specific effect of the anti-reverse current diode (303) will be described later referring to FIG. 5.

In the following, the present invention will be more specifically illustrated referring to Examples. However, it should be understood that these Examples are suggested only for illustration and should not be construed to limit the scope of the present invention.

### EXAMPLE 1

An uninterruptible power supply for the backup of DC power source was constructed as shown in FIG. 2. 2.5 V, 90 F-electric double layer capacitors (available from Enerland Co., Ltd, Korea) were arranged in 11 series and 1 parallel construction to obtain an energy storage device (200) having a withstand voltage of 27.5 V and a capacitance of 8.1 F. A current limiting circuit (101) was constructed by combining a FET (field effect transistor) and a resistor. The current was limited to 0.6 A or lower. A relay (301) was used as a first discharging circuit. Under the combinational action of a voltage detection circuit (102) comprising a reference voltage device and a control circuitry (400) comprising a CPU, the electrochemical capacitor (200) was firstly charged through the current limiting circuit (101) up to 23 V and then the electrochemical capacitor (200) was then connected to the relay (301). A DC/DC converter (302) was used as a second discharging circuit and the output voltage thereof was set to 24 V.

### EXAMPLE 2

An uninterruptible power supply for the backup of DC power source was constructed as shown in FIG. 3. The construction was the same as in Example 1, except that the relay (301) was branched between the DC power source (2) and the output load (3) in a mediation of the anti-reverse current diode (303).

### TEST EXAMPLE 1

### Power Failure Test

In order to test power supply characteristics of the uninterruptible power supplies for the backup of DC power source of Examples 1 and 2, output voltage characteristics of the uninterruptible power supplies of Examples 1 and 2 were measured at a power failure of the input DC power source, using DC power supply (ESF150-24, rated output voltage =24 V, rated output current =6 A, available from Fine Suntronics Co., Ltd.) as an DC power source (2) and a rated power 1 KW, 6 Ω resistance as an output load (3). The results are summarized in FIG. 5 and Table 1. As shown in FIG. 5(a), two instantaneous power interruptions and one long-term power failures were induced successively to the DC power source (2). However, even in the situation, the uninterruptible power supplies of Examples 1 and 2 supplied a constant voltage to the output load (3) for an enlarged period, which is shown in FIG. 5(b). This means that the uninterruptible power supply of the present invention can stably supply the power to the output load even at a momentary power interruption of the DC power source (2). Also, as shown in FIG. 5 and Table 1, the maximum power backup time of the uninterruptible power supply of Example 2 was about 30% longer than that of Example 1 although the same electrochemical capacitor was used. This means that the relay (301) mediated by the anti-reverse current diode (303) further improves the efficiency of the second discharging circuit (302).

TABLE 1

| | Output voltage | Maximum power back up time |
|---|---|---|
| Example 1 | 24 V | 8.2 |
| Example 2 | 24 V | 11.7 |

### TEST EXAMPLE 2

### Output Characteristics Test

In order to test output characteristics of the uninterruptible power supplies for the backup of DC power source of Examples 1 and 2, output voltage characteristics were measured at an abrupt overload in the output load (3), using DC power supply (ESF150-24, rated output voltage =24 V, rated output current =6 A, available from Fine Suntronics Co., Ltd.) as an DC power source (2) and a rated power 1 KW, 6 Ω resistance as an output load (3). The results were summarized in FIG. 6. As shown in FIG. 6(a), in the DC power system without uninterruptible power supply, an instantaneous current rise at the side of the output load resulted in an abrupt voltage drop occurred at the DC power source (2). To the contrary, in the DC power systems equipped with the uninterruptible power supplies of Examples 1 and 2, no voltage drop occurred. This means that the uninterruptible power supply provided by the present invention can protect the DC power source (2) from an instantaneous overload at the output load (3), while maintaining the output characteristics of the DC power source (2).

1. An uninterruptible power supply for the backup of DC (direct current) power source connected in parallel between a DC power source that provides DC energy and an output load that is operated by the DC energy, comprising:
a) an energy storage device that stores extra DC energy from the DC power source;
b) a charging circuitry that charges the extra DC energy from the DC power source into the energy storage device;
c) a control circuitry that controls charging and discharging; and
d) a discharging circuitry that supplies DC energy from the energy storage device to the output load,
wherein the discharging circuitry has a dual output structure comprised of a first discharging circuit that outputs DC energy proportional to a charging voltage of the energy storage device from the energy storage device to the output load, and a second discharging circuit that outputs DC energy having a constant voltage, at a momentary power interruption or a failure of the first charging circuit, from the energy storage device to the output load, and wherein the relay and the DC/DC converter are arranged in parallel.

2. The uninterruptible power supply as set forth in claim 1, wherein the first discharging circuit is a relay and the second discharging circuit is a DC/DC converter.

3. The uninterruptible power supply as set forth in claim 1, wherein the energy storage device is an electrochemical capacitor.

4. The uninterruptible power supply as set forth in claim 1, wherein the charging circuitry comprises a current limiting circuit that charges extra DC energy into the energy storage device at the same voltage with that of the DC power source and a voltage detection circuit that detects an input voltage from the DC power source to the current limiting circuit and an output voltage of the energy storage device.

5. The uninterruptible power supply as set forth in claim 1, wherein an anti-reverse current diode for protecting reverse current flow is interposed in a passage through which the DC energy flows from the first discharging circuit to the output load.
